(19) United States
(12) Patent Application Publication
(10) Pub. No.: US 2004/0059923 A1
(43) Pub. Date: Mar. 25, 2004

(54) Systems and methods for authentication

(76) Inventor: Andrew Divaker ShamRao, Chicago, IL (US)

Correspondence Address: Andrew Divaker ShamRao, Suite 905, 2901 S. Michigan Ave., Chicago, IL, 60616, US

(21) Appl. No.: 10/255,264

(22) Filed: Sep. 25, 2002

(51) Int. Cl. H04L 9/00

(52) U.S. Cl. 713/186

(57) ABSTRACT

A security apparatus includes a removable data storage device to store biometric information; and a security check unit. The security check unit includes a reader adapted to receive the removable data storage device; a scanner adapted to scan user biometric information; and a processor coupled to the reader and the scanner, the processor comparing the biometric information stored on the removable data storage device and the user biometric information from the scanner to allow access to a resource.

This application is related to Ser. No. 09/992,207 entitled “SYSTEMS AND METHODS FOR ENSURING SECURITY AND CONVENIENCE”, Ser. No. 09/992,113 entitled “CONFIGURATION-DEPENDENT DOWNLOAD PROCESS”, Ser. No. 09/992,115 entitled “COMMUNICATION PROCESS FOR RETRIEVING INFORMATION FOR A COMPUTER”, and Ser. No. 09/992,109 entitled “HANDHELD COMPUTER SYSTEMS AND METHODS”, all of which were filed on Nov. 6, 2001 and all share common inventorship, the contents of which are hereby expressly incorporated-by-reference.

### BACKGROUND

The present invention relates generally to a process for authenticating an individual.

Biometric identification refers to a technology that uses scanned graphical information from many sources for evaluation and identification purposes. This would include facial imaging, retinal scans, fingerprint scans, facial scans and voice recognition among many other current and future biometric authentication technologies.

Finger imaging has emerged as one of the most widely used biometric identification application processes where a scan of an individual's finger(s) is taken. The imaging is done electronically, with a computer, rather than with an ink pad. The process is accurate, clean and takes less than five minutes.

One large scale biometric identification deployment is Connecticut's DSS Digital Imaging System which was designed to prevent people from receiving welfare benefits under more than one name or from receiving benefits improperly from more than one town or state program. Digital images are created for every new and existing welfare recipient. These images are stored in a computer database along with a digitally captured facial portrait and signature. As each new applicant is imaged, the digital record is matched against the established database in real time. The equipment used in the digital imaging process includes a computer, an LCD signature tablet, a small optical fingerprint reader, a PVC card printer and a digital camera. Applicants place their two index fingers (one at a time) on the fingerprint scanner. Applicants can see their own fingerprints on the computer screen while the computer “scans” their fingerprints into the central data base. While their fingerprints are being recorded and matched, the system operator will take their photograph and record the applicant's signature. In less than five minutes, a real time match process is completed and the applicant is given a tamper proof, secure photo identification card. The card contains the applicants photo, welfare identification number, a 2D bar-code containing fingerprint minutiae data for fast 1:1 identification verification, and a ISO standard magnetic stripe that can carry everything from EBT financial transaction codes for use in ATM's and POS devices to medical eligibility data for medical service providers.

Such system minimizes fraudulent activities by providing an on-line authentication of users. However, such system is also labor intensive to set up.

### SUMMARY

A security apparatus includes a removable data storage device to store biometric information; and a security check unit. The security check unit includes a reader adapted to receive the removable data storage device; a scanner adapted to scan user biometric information; and a processor coupled to the reader and the scanner, the processor comparing the biometric information stored on the removable data storage device and the user biometric information from the scanner to allow access to a resource.

Implementation of the apparatus may include one or more of the following. The resource comprises activation of a credit card. The resource can be a database, a building, a mode of transportation, an event, or a public gathering. The resource can be the authentication of a driver's license. The processor can rescan the user biometric information upon an initial mismatch. The process can issue a warning upon a mismatch. The removable data storage device can be a Personal Universal Memory (PUM) card adapted to be inserted into a computer. The PUM card can include interface logic to communicate with the processor; and a non-volatile data storage device coupled to the interface logic, the data storage device adapted to store a data structure to store personal information and preferences for customizing the device, wherein the processor transitions from a basic mode to a customized mode upon the insertion of the PUM card. The card can include a magnetic strip or a computer chip positioned on the card. The reader can be either a contact or contactless reader. The reader can receive the card through a groove. Alternatively, the reader can wirelessly or optically access data on the card. Upon authentication or failure to authenticate, the reader generates a meaningful information output (MIO) and sends the MIO to activate a separate process.

The biometric authentication can done using one of three modes: portably using a portable biometric authentication system (PBAS), locally using a local biometric authentication system (LBAS), or centrally using a central biometric authentication system (CBAS).

Advantages of the system may include one or more of the following. The Biometric Authentication (BA) system can be used to secure any information, area, device, machine, or transaction. The biometric system can replace existing cards and would perform the same function those cards used to perform, but with one added step, namely, authentication of the individual's ownership of the card. The benefit of this is that, where before it was not possible to authenticate that the person using the card is the card's rightful owner, with the BA system, it is possible to confirm the individual's ownership of the card.

Because ownership of the card can be authenticated, and because only the authenticated owner of the card can use it, and because only the person whose biometric is stored on the portable device can be authenticated as its true owner, the card can be used to virtually eliminate fraud, theft, and unauthorized access. It can be used to store all kinds of personal information that only the owner of the card can access. This level of security for personal information opens the doors to all kinds of applications for the card including personalized marketing, storage of medical information, storage of preference information, secure monetary transactions, and so on.

### BRIEF DESCRIPTION OF THE DRAWINGS

In the drawings wherein like reference numerals represent like parts:

FIG. 1 shows three embodiments of a biometric authentication (BA) system, respectively.

FIG. 2 shows a process for applying the BA systems or embodiments.

FIG. 3 shows an embodiment of a Portable Biometric Authentication System (PBAS).

FIG. 4 shows an exemplary process for storing an individual's biometric and other information on a portable storage mechanism (PSM).

FIG. 5 shows exemplary processes for the operation of the PBA system of FIG. 3.

FIG. 6 illustrates an embodiment of a central biometric authentication (CBA) system.

FIG. 7 shows exemplary processes for the operation of the CBA system of FIG. 6.

FIG. 8 shows an exemplary local biometric authentication (LBA) system.

FIG. 9 shows an exemplary operational process for storing an individual's biometric and other information on a local storage mechanism (LSM).

FIG. 10 shows exemplary processes for the operation of the LBA system of FIG. 8.

### DESCRIPTION

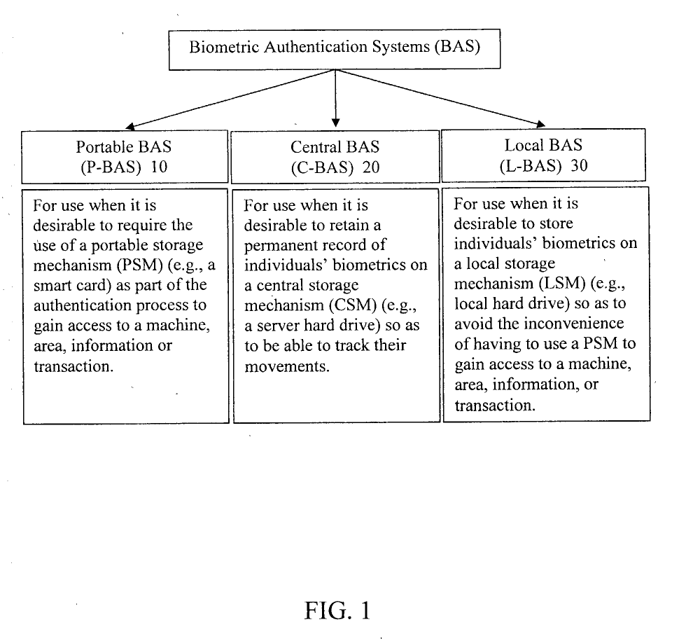

FIG. 1 shows three embodiments 10, 20 and 30 of a biometric authentication (BA) system. A portable BA embodiment 10 is used when it is desirable to require the use of a portable storage mechanism (PSM) (e.g., a smart card) as part of the authentication process to gain access to a machine, area, information or transaction. A central BA embodiment 20 is used when it is desirable to retain a permanent record of individuals' biometrics on a central storage mechanism (CSM) (e.g., a server hard drive) so as to be able to track their movements. Additionally, a local BA embodiment 30 is used when it is desirable to store individuals' biometrics on a local storage mechanism (LSM) (e.g., local hard drive) so as to avoid the inconvenience of having to use a PSM to gain access to a machine, area, information, or transaction.

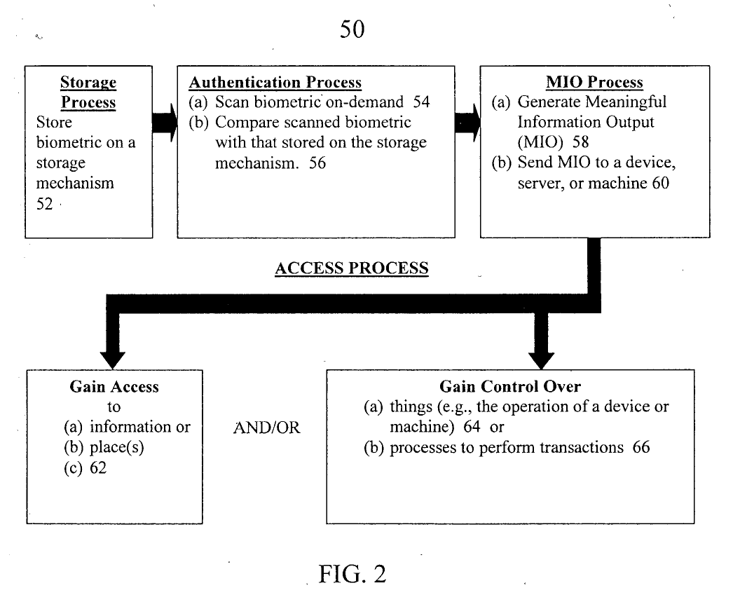

Referring now to FIG. 2, a process 50 for applying the BA systems or embodiments 10, 20 and 30 is shown. Four sub-processes, storage, authentication, meaningful information output (MIO), and access, are performed. First, during a storage sub-process, biometric data is captured and stored on a storage mechanism (52). Next, an authentication sub-process scans biometric on-demand (54) and compares scanned biometric with that stored on the storage mechanism (56). An MIO sub-process then generates the MIO (58) and sends the MIO to a device, server, or machine for storage (60). Next, one of three access options 62, 64 and 66 may be performed. In option 62, the user is granted access to restricted information or area. In option 64, the user gains control over the operation of a device or machine. In option 66, the user is allowed to perform a particular transaction, for example, money transfer or view premium video.

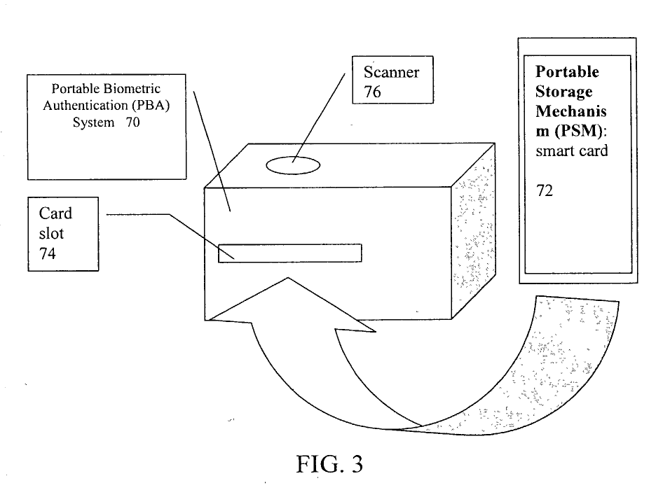

FIG. 3 shows an embodiment of a PBA system. The Portable Biometric Authentication System (PBA system) involves a personal and portable storage mechanism (PSM) for biometric and other kinds of information. An example of a PSM is a smart card, which contains a computer chip on which the information can be stored.

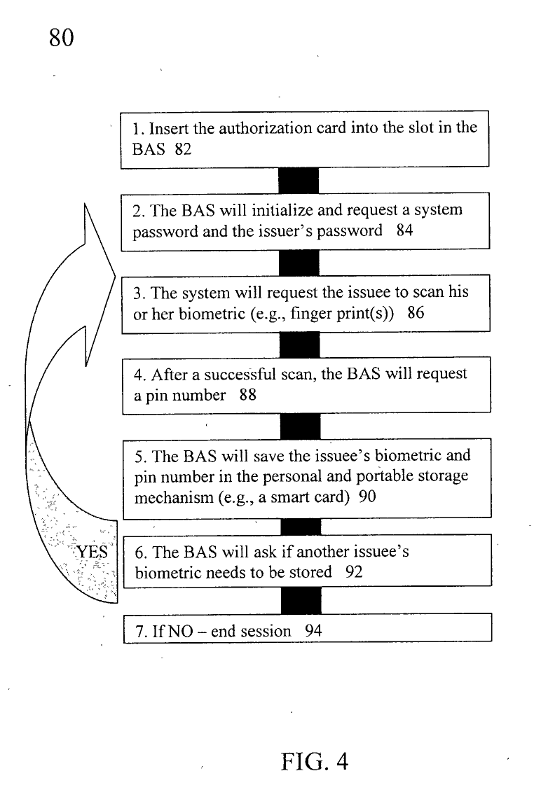

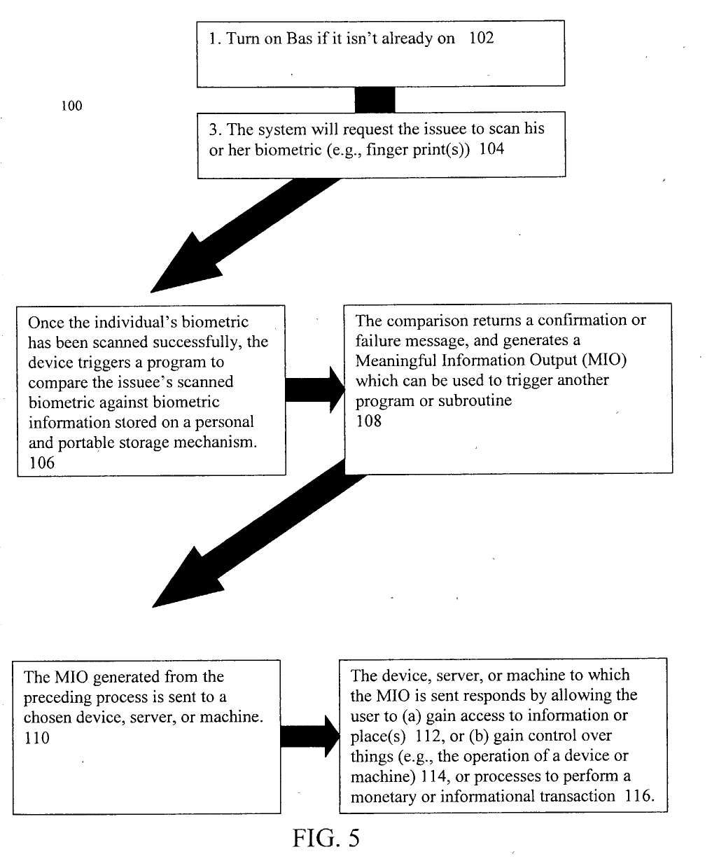

As shown in FIG. 3, an exemplary PBAS 70 receives a PSM such as a smart card 72 in a slot 74. A process 80 (FIG. 4) stores biometric ID information on the card 72. A scanner 76 reads data from the smart card 72 and executes a process 100 (FIG. 5) to authenticate the user.

The PBAS may contain a plurality of buttons on the device, a display screen, a microphone port and a speaker port. A stylus may be slidably stored in a recess along the right side of the device facing the user. The card-reader slot may include a release mechanism for releasing the card. The card is credit card sized and is used for storing user-produced information, such as profile information, preference information, e-mails, addresses, lists, calendar information, and so on.

In one implementation, the card reader in the slot is an internal unit mounted in a recess in the handheld computer. The reader receives the card and electrical contacts on the reader connect electrical fingers that are accessible on the card. The electrical fingers support address bus signals, data bus signals, control bus signals, ground and power signals. These signals are communicated over the electrical fingers so that the processor of the handheld device can access memory or another processor mounted in the handheld computer.

Alternatively, in another implementation, an external reader can be used to read the cards. The external reader is a small device that communicates with the handheld computer over a communication port such as the serial bus. The user then plugs the card into this and it is then directly accessible by the handheld device.

In yet another implementation, the reader can also be a magnetic stripe reader for reading data encoded onto a magnetic strip on the card. In one embodiment, the technique used for encoding magnetic cards is a “Two-Frequency, Coherent Phase Recording” that allows for the representation of single-channel, self-clocking serial data (F/2F). The reader can be motorized to move magnetic cards or can rely on manually moving the card, either through a slotted reader or into an insertion-type reader.

In one embodiment, the PBAS device accepts a removable, replaceable, and upgradeable Central Processing Unit (CPU) used for processing information received from a local server and for processing the user's interaction with the device. The variable characteristic of this wireless CPU is its processing speed in Megahertz. One CPU can be replaced with another that possesses the same or higher processing speed, thus allowing the user greater processing speed and power.

The device also accepts a removable, replaceable, and upgradeable components such as a hard drive, used for storing information received from a local server, such as application modules that allow the user to interact with a local area server. The variable characteristic of this wireless memory component is its memory capacity, such as Read-Only Memory (ROM). One memory component can be replaced with another that possesses the same or higher memory capacity, thus allowing the user more storage space for information downloaded from a local server.

Another component the device can accept is a removable, replaceable, and upgradeable wireless memory component used for storing information to speed up immediate access. The variable characteristic of this wireless memory component is its memory capacity, such as Random Access Memory (RAM) and Cache memory. One memory component can be replaced with another that possesses the same or higher memory capacity, thus allowing the user more storage space for information that requires immediate access, and therefore faster access to the information.

The graphics adapter, used for displaying graphical information received from a local server, is another removable, replaceable, and upgradeable component. The variable characteristic of this removable graphics adapter is its power to handle complex graphics. The removable, replaceable, and upgradeable audio driver 21 allows the user to customize the driver's power to handle complex audio input, including conversion of audio input into digital format for transmission as audio or text files, or as “packets” for internet telephony, or for transmission over cellular technology.

A battery housing compartment can be positioned on the back of the device to receive a battery powering the device. The battery compartment stores a rechargeable or non-rechargeable battery or batteries to power the device. The antenna is retractable; When the device is powered up, the antenna extends to its full length. Conversely, when the device is shut down by means of pressing a button such as the “ON/OFF” button, the antenna 23A retracts automatically. The wireless module can be a Bluetooth module or an 802.11X module.

In Bluetooth wireless module embodiments, the Bluetooth wireless technology allows users to make effortless, wireless and instant connections between various communication devices, such as mobile phones and desktop and notebook computers. Since it uses radio transmission, transfer of both voice and data is in real-time. The sophisticated mode of transmission adopted in the Bluetooth specification ensures protection from interference and security of data. The Bluetooth radio is built into a small microchip and operates in a globally available frequency band ensuring communication compatibility worldwide. The Bluetooth specification has two power levels defined; a lower power level that covers the shorter personal area within a room, and a higher power level that can cover a medium range, such as within a home. Software controls and identity coding built into each microchip ensure that only those units preset by their owners can communicate. The Bluetooth wireless technology supports both point-to-point and point-to-multipoint connections. With the current specification, up to seven ‘slave’ devices can be set to communicate with a ‘master’ radio in one device. Several of these ‘piconets’ can be established and linked together in ad hoc ‘scatternets’ to allow communication among continually flexible configurations. All devices in the same piconet have priority synchronization, but other devices can be set to enter at any time. The topology can best be described as a flexible, multiple piconet structure.

The Bluetooth module enables users to connect a wide range of computing and telecommunications devices easily and simply, without the need to buy, carry, or connect cables. It delivers opportunities for rapid ad hoc connections, and the possibility of automatic, unconscious, connections between devices. It will virtually eliminate the need to purchase additional or proprietary cabling to connect individual devices. Because Bluetooth wireless technology can be used for a variety of purposes, it will also potentially replace multiple cable connections via a single radio link.

For 802.11 embodiments such as 802.11b embodiments, the 802.11 standard provides MAC and PHY functionality for wireless connectivity of fixed, portable and moving stations moving at pedestrian and vehicular speeds within a local area. The IEEE 802.11 standard specifies a wireless connectivity system that standardizes access to one or more frequency bands for local area communications. For customers, the benefit is interoperability between multiple vendor products. The standard defines three physical methods as well as two types of networking. The three different physical layer methods include two using radio frequency and one using infrared. The two radio physical layers operate in 2.4 GHz frequency range, one using frequency hopping spread spectrum (FHSS) and the other using direct sequence spread spectrum (DSSS). The one infrared physical layer operates using baseband infrared. Over the air data rates of 1 Mbps and 2 Mbps are defined in the standard. The IEEE 802.11 standard defines two types of networking, one being ad hoc networking and the other being infrastructure. An ad hoc network is a network composed solely of stations within mutual communication range of each other via the wireless medium. With ad hoc networking, the wireless clients communicate with to each other without the need for a wired network or access points. An infrastructure contains one or more access points which provide wireless clients with access to the wired network.

The PBAS device prompts the user, for example, to place his index finger on the Biometric Identity Scanner, which matches the user's digitalized fingerprint with one stored on the card. If there is a match, the user is informed that he has been authenticated. The PBAS 70 provides one or more of the following functionality:

(a) It allows for the storage of an individual's biometric and other information in a portable storage mechanism (PSM) (e.g., a smart card).

(b) It allows an individual to have sole control and possession of his or her biometric identity, thus, having greater control over his or her privacy.

(c) It can be used to secure virtually any area, equipment, classified information, or transaction by requiring authentication of the individual attempting to gain access.

(d) It can track who attempted to access a specific local area, equipment, information, or transaction and when. This information can be printed, downloaded, or transferred via a modem or other communication means from the LSM prior to deletion.

In one embodiment, if an individual wishes to either (a) gain access to restricted information or areas, (b) gain control over the operation of a device or machine, or (c) perform a monetary or informational transaction, then he/she will be required to go through the authentication process, in which he/she will scan his or her biometric, and that scan will be compared with what is stored in the portable storage mechanism (PSM) for that individual. A match or mismatch will trigger the Meaningful Information Output (MIO) process, in which MIO is generated and sent to a device, server, or machine for storage and/or, in the case of a match, to activate the access process. The access process (a) allows access to restricted information or areas, (b) allows control over the operation of a device or machine, or (c) facilitates a monetary or informational transaction.

The meaningful information output (MIO) can consist of one or more of the following information:

(a) Time of attempted access

(b) Place of attempted access

(c) Who attempted access

(d) Whether authentication was successful

(e) Whether access was granted

(f) A unique identification code that can trigger other processes.

FIG. 4 shows an exemplary process 80 for storing an individual's biometric and other information on a portable storage mechanism (PSM), such as a smart card. The process stores an individual's biometric and other information on a portable storage mechanism (PSM), such as a smart credit card. For this process to work, a device capable of writing biometric information on a computer chip, and an authorization card used to operate the biometric writer are required. When a biometric authentication system is purchased, it comes with an authorization card. This authorization card is issued to a designated individual with the authority to take biometric scans of individuals. This individual is known as the issuer, an individual who is authorized to issue a smart card to any individual (e.g., customer). The smart card can be used to perform a variety of transactions, and the individual who is using the card can verify that he or she is the owner of that card by engaging in the biometric authentication process. An issue is the individual (e.g., customer) who permits the storage of his/her biometric on a personal and portable storage mechanism (e.g., smart card) and takes possession of it for future use.

Insert the authorization card into the slot in the BAS (82). The BAS will initialize and request a system password and the issuer's password (84). The system will request the issuee to scan his or her biometric (e.g., finger print(s)) (86). After a successful scan, the BAS will request the issuee to enter a pin number (88). The BAS will save the issuee's biometric in the personal and portable storage mechanism (e.g., a smart card) (90). The BAS will ask if another issuee's biometric needs to be stored (92). If not, the process exits (94).

Turning now to FIG. 5, the process 100 is detailed. First, the process turns on the PBAS if it isn't already on (102). Next, the process requests the issuee to scan his or her biometric (e.g., finger print(s)) (104). The process then compares the scanned biometric with that which is stored on the PSM and generating Meaningful Information Output (MIO) that can be used to trigger other processes (106). In one embodiment, once the individual's biometric has been scanned successfully, the device triggers a program to compare the issuee's scanned biometric against biometric information stored on a personal and portable storage mechanism (108). The comparison returns a confirmation or failure message, and generates a Meaningful Information Output (MIO) which can be used to trigger another program or subroutine (110).

Next, a process for sending the MIO to a chosen device, server, or machine to either (a) gain access to restricted information or areas, (b) gain control over the operation of a device or machine, or (c) to perform a monetary or informational transaction (112). In this operation, the MIO generated from the preceding process is sent to a chosen device, server, or machine (114), and the device, server, or machine to which the MIO is sent responds by allowing the user to (a) gain access to restricted information or areas, (b) gain control over the operation of a device or machine, or (c) to perform a monetary or informational transaction (116).

The PBA system can be used to secure any information, area, device, machine, or transaction. A portable storage mechanism (PSM), such as a smart card can be used to gain access to various secured systems that currently require the use of a credit card, bankcard, debit card, driver's license, passport, or other type of functional card. Thus, this new biometric system would replace existing cards and would perform the same function those cards used to perform, but with one added step, namely, authentication of the individual's ownership of the PSM. The benefit of this is that, where before it was not possible to authenticate that the person using the card is the card's rightful owner, with the PBA system, it is possible to confirm the individual's ownership of the PSM.

The following are examples of uses for the portable biometric authentication (PBA) system.

1. Using a PBA System to Combat Credit Card Fraud and Identity Theft

One specific application involves the use of a PBA system to prevent fraud and identity theft in the credit card industry. In this case, the credit card will contain a chip on which the owner's biometric is stored, along with other credit card information pertinent to the individual's credit rating. Prior to any transaction, the owner will be required to authenticate his or her ownership of the card by going through the authentication and MIO processes. The MIO generated can be used to activate the credit authorization process currently used in the industry (which may include the entry of a password), after which, the individual will be allowed to proceed with the transaction. If a mismatch occurs, a second and third attempt will be allowed. After the third attempt security procedures appropriate to the situation will be enacted. This authentication method can be applied for online and offline transactions. Users would have to be issued, or would have to purchase a card reader to conduct online transaction from home.

By using a PSM, such as a smart card, instead of a standard credit card, one can be sure that the individual using the credit card actually owns that card. A smart credit card can be used for other commercial applications in which it is used to store an e-ticket, for example, to gain access to events or places such as Capitol Hill, a concert, or an airplane.

2. Using a PBA System to Authenticate the Owner of a Driver's License

Another application involves the use of a smart drivers license. A PBA system using smart drivers licenses can be used to verify that the individual in possession of a driver's license is its rightful owner. In this case, the individual's driver's license card will contain a chip on which the owner's biometric and other information (e.g., individual's name, address, license number, date of birth, etc.) is stored. Note that a picture would not be a part of the ID card for the reason presented below. The driver's license can be used anywhere in the country, at any event, to authenticate it's owner. It would amount to a national I.D. card.

In the event that a police officer wants to authenticate the owner of a driver's license, he would ask the individual to go through the authentication and MIO processes. The MIO generated would include the individual's name, address, license number, date of birth, and any other pertinent information. The MIO would be sent to a server, which would compare the MIO against what is stored in the law-enforcement database. The server would send back confirmation of a match, along with the picture of the individual so that the police officer can make a visual confirmation of the owner of the I.D. card. A mismatch of MIO against what is in the database will result in a failure message and security procedures appropriate to the situation will be enacted.

3. Using a PBA System to Alert Security about Individuals With Criminal Records or with a Visa

Prior to entering a building, mode of transportation, event, or public gathering, the owner will be required to authenticate his or her ownership of the I.D. card (e.g., driver's license) by going through the authentication and MIO processes. The MIO generated will include a code specifying whether the individual has a criminal record, or is a visa holder (foreign citizen). When foreigners or individuals with a criminal record are flagged, security would have the option to conduct a more thorough security check. The more thorough security check might involve using the MIO to activate a routine to match the identification information stored on the card with that which is in a law-enforcement database.

For law-enforcement purposes, the program can be written to allow comparison of the fingerprint stored on the card with that stored in the law-enforcement database for only those individuals who have criminal records or have a visa. This helps protect the right to privacy of law-abiding citizens of the United States. Once authenticated, the individual will be allowed to proceed. Depending on the level of security required, subsequent authentications could be required at various planned or random checkpoints. If a mismatch occurs, a second and third attempt will be allowed. After the third attempt security procedures appropriate to the situation will be enacted.

4. Using a PBA System to Confirm the Identity of a Person Attempting to Access or Write to a Database

The right to privacy warrants authentication of someone attempting to access a database of information about customers or patients, for example. Authentication of individuals who make inputs to a database can be desirable to prevent fraud or to track the source of errorful inputs so as to circumvent them. For such applications, the individual's identification card (driver's license, credit card, or an organization-issued I.D. card) will contain a chip on which the owner's biometric and other identifying information (e.g., division, department, position, title, supervisor, date employed, or patient identification information) is stored.

Prior to accessing a database, the individual will be required to authenticate his or her ownership of the I.D. card by going through the authentication and MIO processes. The MIO generated can be used to activate a routine to match the employee information stored on the card with that which is in the database of authorized users. If a mismatch occurs, a second and third attempt will be allowed. After the third attempt security procedures appropriate to the situation will be enacted. Once authenticated, the individual will be allowed to access the database. Different levels of authentication can be required for reading a database versus writing to it.

5. Using a PBA System to Confirm the Ownership of a Commercial Ticket for Entry into a Building, Mode of Transportation, Event, or Public Gathering.

In this application, authenticating the ownership of a PSM will generate MIO, which can be matched against a database of commercial transactions to authenticate the ownership of a commercial ticket for entry into a building, mode of transportation, event, or public gathering. In this case, the individual's identification card (driver's license, credit card, or an organization-issued I.D. card) will contain a chip on which the owner's biometric and other information (e.g., airline ticket information, or ticket information for an entertainment event) is stored.

Prior to entering a building, mode of transportation, event, or public gathering, the owner will be required to authenticate his or her ownership of the card by going through the authentication and MIO processes. The MIO generated can be used to activate a routine to match the information stored on the card (e.g., airline ticket information, or ticket information for an entertainment event) with that which is in the database. Once authenticated, the individual will be allowed to enter a building, mode of transportation, event, or public gathering. Subsequent authentications can be required at various planned or random checkpoints, depending on the level of security required. If a mismatch occurs, a second and third attempt will be allowed. After the third attempt security procedures appropriate to the situation will be enacted.

6. Using a PBA System to Deliver Personalized Information.

To deliver personalized information to a customer, the customer must be able to modify the contents of the personal storage mechanism (PSM). Therefore, a device capable of allowing individuals to view and edit the content of their PSM is necessary. A logical device for such a purpose is a portable handheld device, such as a PDA or tablet PC or some hybrid between them. In this case the individual would authenticate his ownership of the PSM and then edit his preferences for a shopping list, for example. This information would be stored on his PSM. Doing this in a mall that is equipped to deliver preference-based advertising wirelessly would facilitate the delivery of personalized information about sales related to the individual's shopping list. The ads can be viewed on the portable handheld device. Because all of the information is stored on the PSM, the device itself can be rented or loaned for one-time use in a mall, airport, train station, library, school and so on.

7. Using a PBA System to Personalize One's Internet Experience when not at Home.

By using a device that can write to a PSM, an individual can save settings for his personal computer including, fonts, browser settings, URLs for his favorite Internet sites, cookies etc., on the PSM. When using a “public” computer at the library or at an Internet café that accepts the PSM, the owner of the PSM can personalize his experience on the computer by accessing his settings from the PSM after authenticating his ownership of the PSM. If the owner sets the PSM to accept cookies when online, that can further personalize the individual's experience when he returns to a computer after having been away for a while.

The PBA system is versatile in its applications and can address virtually any security concern related to authenticating an individual's identity. However, there are times when it may be desirable to store the biometrics of certain segments of a population on a central storage mechanism. Those populations may include individuals with a criminal record, foreigners, and employees who work in highly restricted areas. In these situations, a central biometric authentication (CBA) system may be necessary.

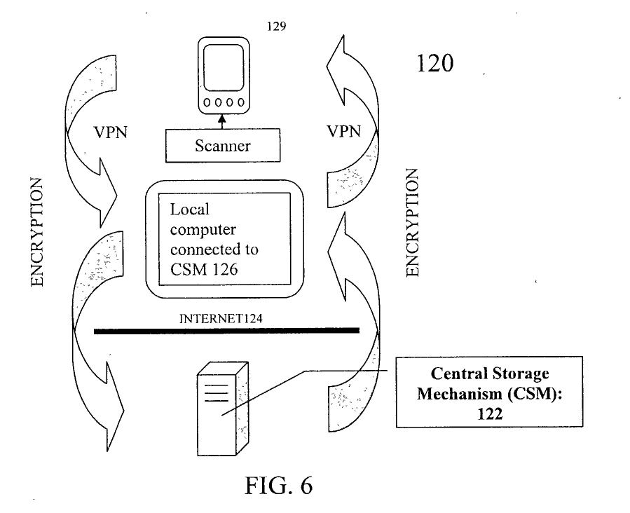

FIG. 6 illustrates an embodiment of the CBA system 120. The system 120 includes a central storage mechanism (CSM) 122 connected by a network or over the Internet 124 to a local computer system 126, which in turn communicates over a secure network 128 such as a virtual private network (VPN) with authentication devices 130. The CBA System 120 can include one or more of the following functionality:

(a) A CBA system allows for the storage of an individual's biometric and other information in a central storage mechanism (CSM) (e.g., a central server hard drive).

(b) Because of the extensive storage capacity of a CSM for biometric information, a CBA system can be used to secure virtually any area, equipment, classified information, or transaction, regardless of the number of people whose identity would need to be authenticated.

(c) Because the CBA system uses a central storage mechanism, it permits the tracking of any individual's movements when and wherever (potentially, anywhere in the country) he attempts to authenticate his identity, assuming that the authentication system used is connected via a network to the central storage mechanism. This access information can be printed, downloaded, or transferred via a modem or other communication means from the CSM.

As with the portable biometric authentication (PBA) system, with a the central biometric authentication (CBA) system, an individual who wishes to either (a) gain access to restricted information or areas, (b) gain control over the operation of a device or machine, or (c) perform a monetary or informational transaction, will be required to go through the authentication and MIO processes.

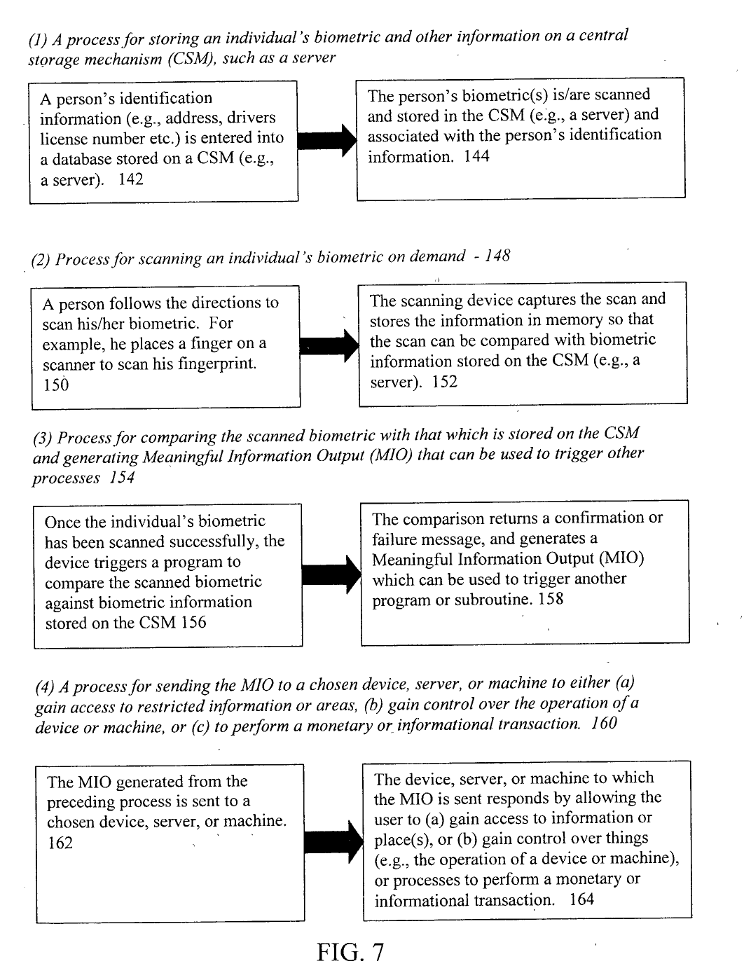

FIG. 7 shows an exemplary process 140 showing the operation of the system of FIG. 6. First, the process stores an individual's biometric and other information on a central storage mechanism (CSM), such as a server (142). A person's identification information (e.g., address, drivers license number etc.) is entered into a database stored on a CSM (e.g., a server) (144). The person's biometric(s) is/are scanned and stored in the CSM (e.g., a server) and associated with the person's identification information (146).

Next, the process scans an individual's biometric on demand (148). This operation includes instructing a person to follow the directions to scan his/her biometric. For example, he places a finger on a scanner to scan his fingerprint (150). The scanning device captures the scan and stores the information in memory so that the scan can be compared with biometric information stored on the CSM (e.g., a server) (152).

Next, the process compares the scanned biometric with that which is stored on the CSM and generating Meaningful Information Output (MIO) that can be used to trigger other processes (154). In this operation, once the individual's biometric has been scanned successfully, the device triggers a program to compare the scanned biometric against biometric information stored on the CSM (e.g., a server) (156). The comparison returns a confirmation or failure message, and generates a Meaningful Information Output (MIO) which can be used to trigger another program or subroutine (158).

The process 140 then sends the MIO to a chosen device, server, or machine to either (a) gain access to restricted information or areas, (b) gain control over the operation of a device or machine, or (c) to perform a monetary or informational transaction (160). The MIO generated from the preceding process is sent to a chosen device, server, or machine (162). Next, the device, server, or machine to which the MIO is sent responds by allowing the user to (a) gain access to restricted information or areas, (b) gain control over the operation of a device or machine, or (c) to perform a monetary or informational transaction (164).

The CBA system is useful for government or military agencies, such as the Pentagon, Immigration and Naturalization Service (INS), the State Department, and city and state police departments, where highly restrictive access to areas, equipment, and information, or the ability to track the movements of an individual is necessary. For example, the INS may want to track the movements of foreign individuals, or police departments may want to track the movements of individuals with criminal records. These applications require an agency to permanently store in a central database the biometric and other identification information of foreigners, individuals with criminal records, and of government employees who have been given long-term authorization to have access to restricted areas, equipment, and/or classified information. When these individuals attempt to authenticate themselves, a permanent record of their attempt is stored.

One limitation of using a CBA system is the expense of deploying it. It would require hardware and wiring to enable biometric scanners to access a central database against which an on-demand biometric scan is compared. Another problem is that the storage of biometrics in a government or other central storage mechanism exposes the individual, whose biometric is stored, to potential invasion of privacy. While such measures may be necessary for situations in which highly restricted locations, equipment and classified information are involved, they are not necessary, or justified, for use in less restrictive settings, events, and for access to unclassified information. For this reason, the concepts of “portable” and “local,” biometric authentication systems are required.

On occasions when carrying around a PSM all the time might be a hassle, particularly when one has to access an area, machine, information, or transaction frequently, a local biometric authentication system (LBA system) might be of more use.

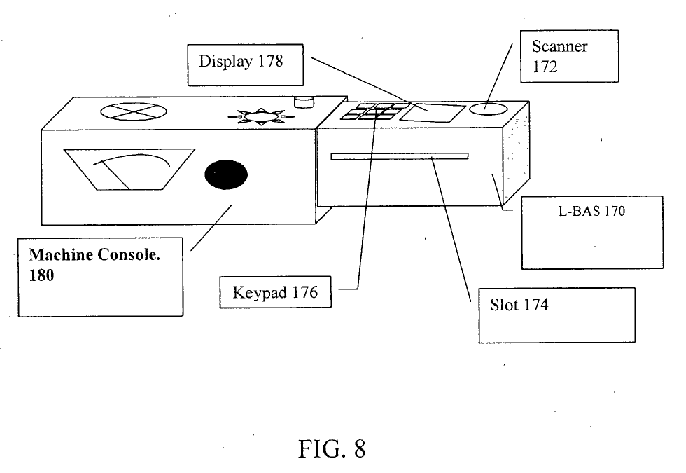

FIG. 8 shows an exemplary LBA system 170, which is a device attached to the console of a machine. The device has a small fingerprint scanner 172 on its face, and a slot 174 into which a card, the size of a credit card, can be inserted. The LBA system 170 involves a local storage mechanism (LSM) for biometric and other kinds of information. The storage capacity of the LSM would be limited. The LBA System can provide the following functionality:

(a) A LBA system allows for the storage of an individual's biometric and other information in a local storage mechanism (LSM) (e.g., a local hard drive).

(b) Because of its limited storage capacity, it is best used to secure only those areas, equipment, classified information, or transactions that a limited number of people are authorized to access.

(c) It can track who accessed a specific local area, equipment, or classified information, and when it was accessed. This information can be printed, downloaded, or transferred via a modem or other communication means from the LSM prior to deletion.

As with the PBA and CBA system, with a the local biometric authentication (LBA) system, an individual who wishes to either (a) gain access to restricted information or areas, (b) gain control over the operation of a device or machine, or (c) perform a monetary or informational transaction, will be required to go through the authentication and MIO processes.

The storage of biometrics in a local storage mechanism (LSM) is useful because in many companies, employee positions change and their access to restricted areas, equipment, and information also changes with their position. Therefore, it is necessary to have a system with a storage mechanism that can be readily overwritten, and does not depend on a central storage mechanism (CSM) and extensive wiring for comparing a biometric scan. Independence from a central database increases efficiency and reduces cost of deploying security.

The LBA System can be used in situations where a limited few are authorized to operate a machine, vehicle, other means of transportation, change settings on equipment, open a cash register at a store, access a room where classified records are stored, or to access a database. For example, such a system can be deployed for entire transportation fleets such as airplanes, buses, trains, rental cars, rental trucks, semi trucks and so on, with the objective to restrict control of the vehicle to a few operators and to thereby prevent the possibility of a vehicle being hijacked. In this case, the authorized operator's biometric(s) will be stored in a fixed and local storage mechanism attached to the mode of entrance or to the operating console of a machine or vehicle.

In addition to storing the biometric, other information (e.g., settings for various operations of the machinery that are particular to the operator) can be stored in the local storage mechanism (LSM). The effect of authentication would be to unlock either the mode of entrance into the machinery, for example the door of a vehicle, and/or to give access to a process for starting the machinery, and/or to give access to a process for changing the setting of various operations within the machinery. Requiring a biometric scan to authenticate one's identity and authority to operate the vehicle increase security. In these situations, it is not necessary or desirable to use a Central biometric Authentic (CBA) System. A local scan and comparison is sufficient, with a record of the date and time of the scan, whether access was granted, and who attempted access temporarily stored in the LSM and transmitted to a central storage mechanism (CSM) or printer.

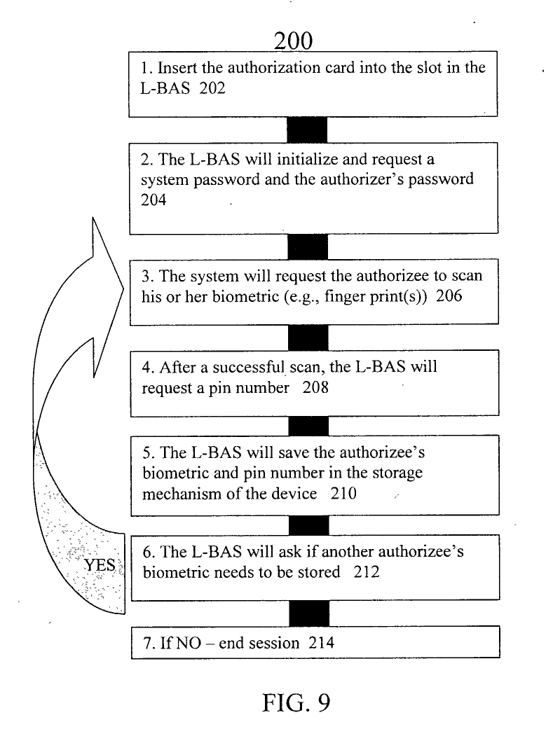

FIG. 9 shows an exemplary operational process 200 for storing an individual's biometric and other information on a local storage mechanism (LSM). When a biometric authentication system is purchased, it comes with an authorization card. This authorization card is issued to a designated individual with the authority to take biometric scans of individuals. This individual is known as the authorizer, someone who is empowered (e.g., a supervisor) to authorize another individual (e.g., an employee) to have access to a machine, restricted area, or to classified information. An authorizee is the individual (e.g., employee) who was authorized by the authorizer to have access to a machine, restricted area, or to classified information.

The process for storing an individual's biometric and other information on a local storage mechanism (LSM) includes requesting the user to insert the authorization card into the slot in the L-BAS (202). The L-BAS will initialize and request a system password and the authorizer's password (204). The system will request the authorizee to scan his or her biometric (e.g., finger print(s)) (206). After a successful scan, the L-BAS will request the authorizee to enter a pin number (208). The L-BAS will save the authorizee's biometric in the storage mechanism of the device (210). The L-BAS will ask if another authorizee's biometric needs to be stored (212). If yes, the process loops back to 206, and if no, the process exits (214).

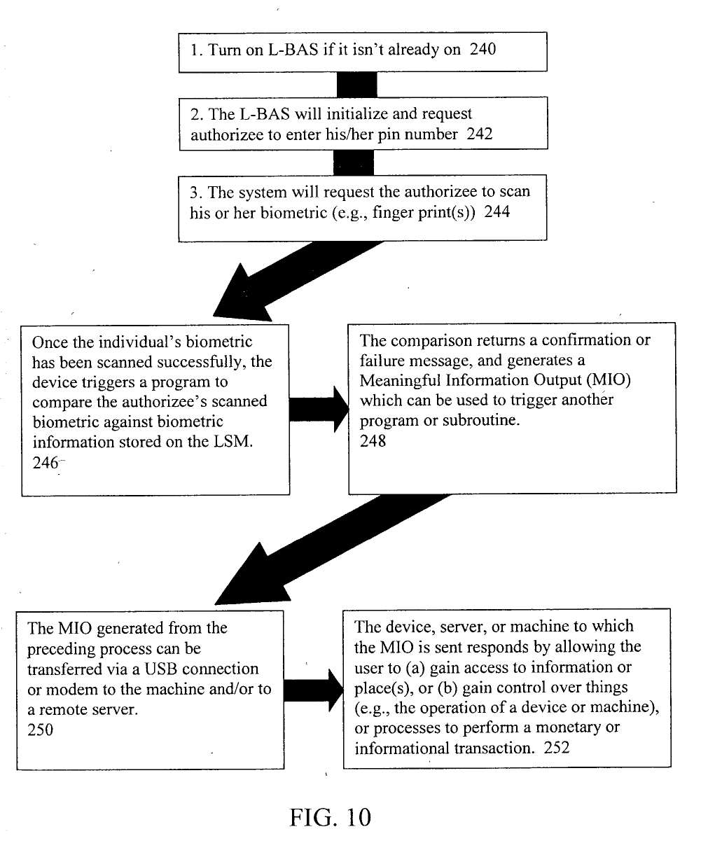

FIG. 10 shows an exemplary process for scanning an individual's biometric on demand using the LBA system. First, the process turns on L-BAS if it isn't already on (240). The L-BAS will initialize and request authorizes to enter his/her pin number (242). The system will request the authorizee to scan his or her biometric (e.g., finger print(s)) (244). Once the individual's biometric has been scanned successfully, the device triggers a program to compare the authorizee's scanned biometric against biometric information stored on the LSM (246). The comparison returns a confirmation or failure message, and generates a Meaningful Information Output (MIO) which can be used to trigger another program or subroutine (248). The MIO generated from the preceding process can be transferred via a USB connection or modem to the machine and/or to a remote server (250). The device, server, or machine to which the MIO is sent responds by allowing the user to (a) gain access to information or place(s), or (b) gain control over things (e.g., the operation of a device or machine), or processes to perform a monetary or informational transaction (252).

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A security apparatus, comprising:
a removable data storage device to store biometric information; and
a security check unit including:
a reader adapted to receive the removable data storage device;
a scanner adapted to scan user biometric information; and
a processor coupled to the reader and the scanner, the processor comparing the biometric information stored on the removable data storage device and the user biometric information from the scanner to allow access to a resource.

2. The security apparatus of claim 1, wherein the resource comprises activation of a credit card.

3. The security apparatus of claim 1, wherein the resource comprises a database.

4. The security apparatus of claim 1, wherein the resource comprises a building.

5. The security apparatus of claim 1, wherein the resource comprises a mode of transportation.

6. The security apparatus of claim 1, wherein the resource comprises an event.

7. The security apparatus of claim 1, wherein the resource comprises a public gathering.

8. The security apparatus of claim 1, wherein the resource comprises authentication of a driver's license.

9. The security apparatus of claim 1, wherein the processor rescans the user biometric information upon an initial mismatch.

10. The security apparatus of claim 1, wherein the processor issues a warning upon a mismatch.

11. The security apparatus of claim 1, wherein the removable data storage device comprises a Personal Universal Memory (PUM) card adapted to be inserted into a computer.

12. The security apparatus of claim 1, wherein the PUM card further comprises:
interface logic to communicate with the processor; and
a non-volatile data storage device coupled to the interface logic, the data storage device adapted to store a data structure to store personal information and preferences for customizing the device, wherein the processor transitions from a basic mode to a customized mode upon the insertion or contactless scanning of the PUM card.

13. The security apparatus of claim 1, wherein the PUM card comprises a memory device.

14. The security apparatus of claim 1, wherein the card further comprises a magnetic strip or computer chip positioned on the card.

15. The security apparatus of claim 1, wherein the reader comprises a contact reader.

16. The security apparatus of claim 1, wherein the reader comprises a contactless reader.

17. The security apparatus of claim 1, wherein the reader receives the card through a groove.

18. The security apparatus of claim 1, wherein the reader wirelessly or optically accesses data on the card.

19. The security apparatus of claim 1, wherein upon authentication or failure to authenticate, the reader generates a meaningful information output (MIO) and sends the MIO to activate a separate process.

20. The security apparatus of claim 1, wherein the biometric authentication is done portably using a portable biometric authentication system (PBAS), locally using a local biometric authentication system (LBAS), or centrally using a central biometric authentication system (CBAS).
